(19) United States
(12) Patent Application Publication
(10) Pub. No.: US 2015/0180955 A1
(43) Pub. Date: Jun. 25, 2015

(54) MANAGEMENT APPARATUS AND CONTROL METHOD THEREFOR FOR MANAGING A NETWORK DEVICE

(71) Applicant: CANON KABUSHIKI KAISHA, Tokyo (JP)

(72) Inventor: Takeshi Nakagawara, Kawasaki-shi (JP)

(21) Appl. No.: 14/580,075

(22) Filed: Dec. 22, 2014

(30) Foreign Application Priority Data
Dec. 25, 2013 (JP) 2013-267432

(51) Int. Cl. H04L 29/08; H04L 29/06

(52) U.S. Cl. CPC H04L 67/10; H04L 67/42

(57) ABSTRACT

A management application manages, as a script, an instruction required for an operation on a multifunction peripheral (MFP) and issued via a web page provided by the MFP, and executes the operation on the MFP via the web page provided by the MFP by use of the script. Moreover, the management application acquires configuration information of the MFP, and determines, based on the acquired configuration information of the MFP, whether the managed script needs to be corrected. If it is determined that the managed script needs to be corrected, the management application corrects the script, and manages the corrected script.

### BACKGROUND OF THE INVENTION

1. Field of the Invention

The present invention relates to a technique of managing a network device.

2. Description of the Related Art

Heretofore, managing a network device, such as an image forming apparatus, via a management server or the like has required the use of a protocol unique to the manufacturer (hereinafter referred to as a “vendor”) of the network device.

Japanese Patent Application Laid-Open No. 2010-72758 discusses a technique of applying a data definition language (DDL)-based program provided for each vendor to software that manages network devices.

However, recently, a technique of managing a network device without the use of a program unique to a vendor, for example, a technique of managing a network device with the use of web scraping, has been attracting attention, and improvements of such a technique have been awaited.

### SUMMARY OF THE INVENTION

The present invention is directed to a scheme capable of continuing to manage a network device even when a configuration of the network device has been changed.

According to an aspect of the present invention, a management apparatus includes a management unit configured to manage, as a script, an instruction required for an operation on a network device and issued via a web page provided by the network device, an execution unit configured to execute the operation on the network device via the web page provided by the network device by use of the script managed by the management unit, an acquisition unit configured to acquire configuration information of the network device, a determination unit configured to determine, based on the configuration information of the network device acquired by the acquisition unit, whether the script managed by the management unit needs to be corrected, and a correction unit configured to correct the script if it is determined by the determination unit that the script managed by the management unit needs to be corrected, wherein the management unit manages the script corrected by the correction unit.

Further features of the present invention will become apparent from the following description of exemplary embodiments with reference to the attached drawings.

### BRIEF DESCRIPTION OF THE DRAWINGS

FIG. 1 illustrates an example hardware configuration of a network system according to an exemplary embodiment of the present invention.

FIG. 2 illustrates an example software configuration of the network system according to the exemplary embodiment of the present invention.

FIG. 3A illustrates examples of configurations of various tables according to the exemplary embodiment of the present invention.

FIG. 3B illustrates examples of configurations of various tables according to the exemplary embodiment of the present invention.

FIG. 3C illustrates examples of configurations of various tables according to the exemplary embodiment of the present invention.

FIG. 4 illustrates an example of description of a script according to the exemplary embodiment of the present invention.

FIG. 5 is a flowchart illustrating an example operation of an application server according to a first exemplary embodiment.

FIG. 6 illustrates an example of a correction screen for a script according to the first exemplary embodiment.

FIG. 7 illustrates an example of a web user interface (UI) operation screen according to the first exemplary embodiment.

FIG. 8 is a flowchart illustrating an example operation of an application server according to a second exemplary embodiment.

FIG. 9 is a flowchart illustrating an example operation of an application server according to a third exemplary embodiment.

### DESCRIPTION OF THE EMBODIMENTS

Various exemplary embodiments, features, and aspects of the invention will be described in detail below with reference to the drawings.

The following describes a network system including a management apparatus that manages a network device according to an exemplary embodiment of the present invention. Here, an application server is described as an example of the management apparatus. Furthermore, a multifunction peripheral (MFP) is described as an example of the network device according to the present exemplary embodiment. The network device also includes other than MFPs, such as a printer and a facsimile machine.

Furthermore, in the context of the present specification, a program operating a web UI of the network device, analyzing a language, and extracting information is described by the use of the term “web scraping”. In the present specification, the term “web scraping” means a technique of extracting information about a network device by operating a web UI according to a description procedure of a script and analyzing HyperText Markup Language (HTML) information, and operating the web UI by simulating input processing, such as a mouse operation and a keyboard operation.

Examples of uses of web scraping include changing various settings of the network device to arbitrary values or distributing and installing a particular application or a license file, such as a certificate, using a file upload function. Furthermore, the use of web scraping can be periodically acquiring various statuses of the network device from the web UI and monitoring the state of the network device. As a matter of course, web scraping may be used for other applications.

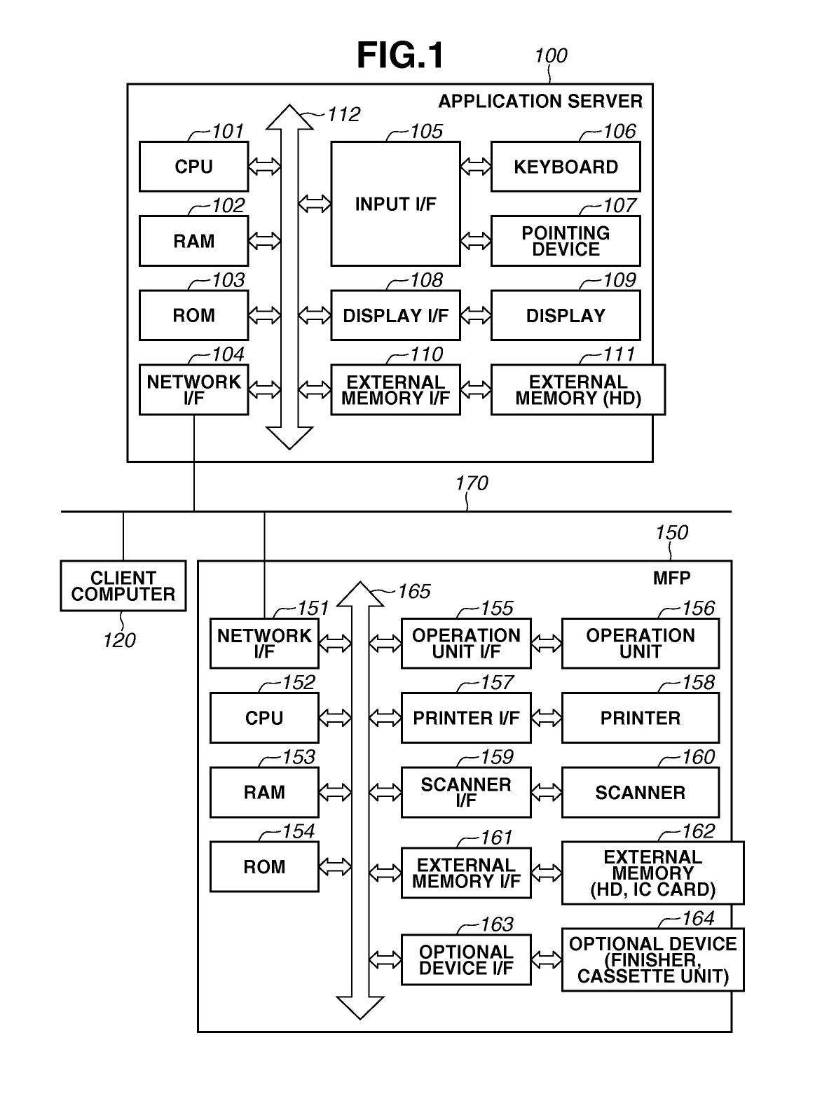

FIG. 1 is a block diagram illustrating an example of a system configuration and a hardware configuration of the network system including a management apparatus according to an exemplary embodiment of the present invention.

The network system includes an application server 100, one or more client computers 120, and one or more MFPs 150 (network devices), which are interconnected via a network 170. The application server 100 and the client computer 120 have general-purpose computer configurations. The hardware configuration of the client computer 120 is similar to that of the application server 100 and is, therefore, omitted from the following description.

The application server 100 includes a central processing unit (CPU) 101, which executes processing based on an application program or the like stored in a read-only memory (ROM) 103 or an external memory 111. The CPU 101 also comprehensively controls various devices connected to a system bus 112. Furthermore, the CPU 101 opens various application windows registered based on commands issued via a mouse cursor or the like (not illustrated) displayed on a display 109, and executes various data processing operations.

A random access memory (RAM) 102 functions as a main memory or a work area for the CPU 101. The ROM 103 is a read-only memory functioning as a storage region for a basic input and output (I/O) program. The ROM 103 or the external memory 111 stores an operating system program (hereinafter referred to as an “OS”), which is a control program for the CPU 101. The ROM 103 or the external memory 111 also stores files and other various pieces of data that are used to perform processing based on the above-mentioned application program.

A network interface (I/F) 104 connects to the network 170 to perform network communications. An input I/F 105 controls inputs from a keyboard 106 and a pointing device 107, such as a mouse. A display I/F 108 controls a display operation of the display 109. An external memory I/F 110 controls access to the external memory 111, such as a hard disk drive (HD) or a solid-state drive (SSD). The external memory 111 stores a boot program, various applications, user files, and editing files.

The application server 100 operates with the CPU 101 executing the basic I/O program and the OS written in the ROM 103 or the external memory 111. The basic I/O program is written in the ROM 103, and the OS is written in the ROM 103 or the external memory 111. Then, when the computer is powered on, an initial program loading function included in the basic I/O program writes the OS from the ROM 103 or the external memory 111 into the RAM 102, and the OS then starts its operation. The system bus 112 interconnects the various devices.

The MFP 150 includes a network I/F 151, which connects to the network 170 to perform network communications. A CPU 152 outputs an image signal as output information to a printer 158 via a printer I/F 157, which is connected to a system bus 165, based on a control program. The control program is stored in a ROM 154 or an external memory 162.

Furthermore, the CPU 152 is capable of performing communication processing with computers via the network I/F 151, and is thus able to notify the application server 100 of information about the MFP 150. Furthermore, the CPU 152 performs processing based on an application program stored in the ROM 154 or the external memory 162.

A RAM 153 functions as a main memory or a work area for the CPU 152 and is configured to allow its memory capacity to be expanded with an optional RAM connected to an expansion port (not illustrated). The RAM 153 is used for an output information rasterizing region, an environment data storage region, and a nonvolatile random access memory (NVRAM).

The external memory 162 is, for example, a hard disk drive (HD), a solid-state drive (SSD), or an integrated circuit (IC) card. The ROM 154 or the external memory 162 stores a control program for the CPU 152, an application program, font data used to output the above-mentioned output information, and information usable in the MFP 150. Furthermore, the ROM 154 or the external memory 162 temporarily stores an application at the time of installation of the application on the MFP 150.

An operation unit I/F 155, which serves as an interface with an operation unit 156, outputs, to the operation unit 156, image data to be displayed on the operation unit 156. Furthermore, the operation unit I/F 155 receives information input by the user via the operation unit 156. The operation unit 156 is, for example, an operation panel including switches for operation and light-emitting diode (LED) indicators.

The printer I/F 157 outputs an image signal as output information to the printer 158 (a printer engine). A scanner I/F 159 receives an image signal as input information from a scanner 160 (a scanner engine).

An external memory I/F 161 (a memory controller) controls access to the external memory 162. The number of external memories 162 is not limited to one. At least one external memory 162 may be provided such that a plurality of external memories storing, in addition to built-in fonts, optional font cards and a program for interpreting printer control languages of different language systems is connected. Furthermore, the external memory 162 may include an NVRAM (not illustrated) to store printer mode setting information input via the operation unit 156.

An optional device I/F 163 controls access to an optional device 164, such as a finisher or a cassette unit. The optional device 164 may be, in addition to a finisher or a cassette unit, a peripheral device for expanding functions and mechanisms of the MFP 150, such as a camera or an IC card reader. The system bus 165 interconnects various devices.

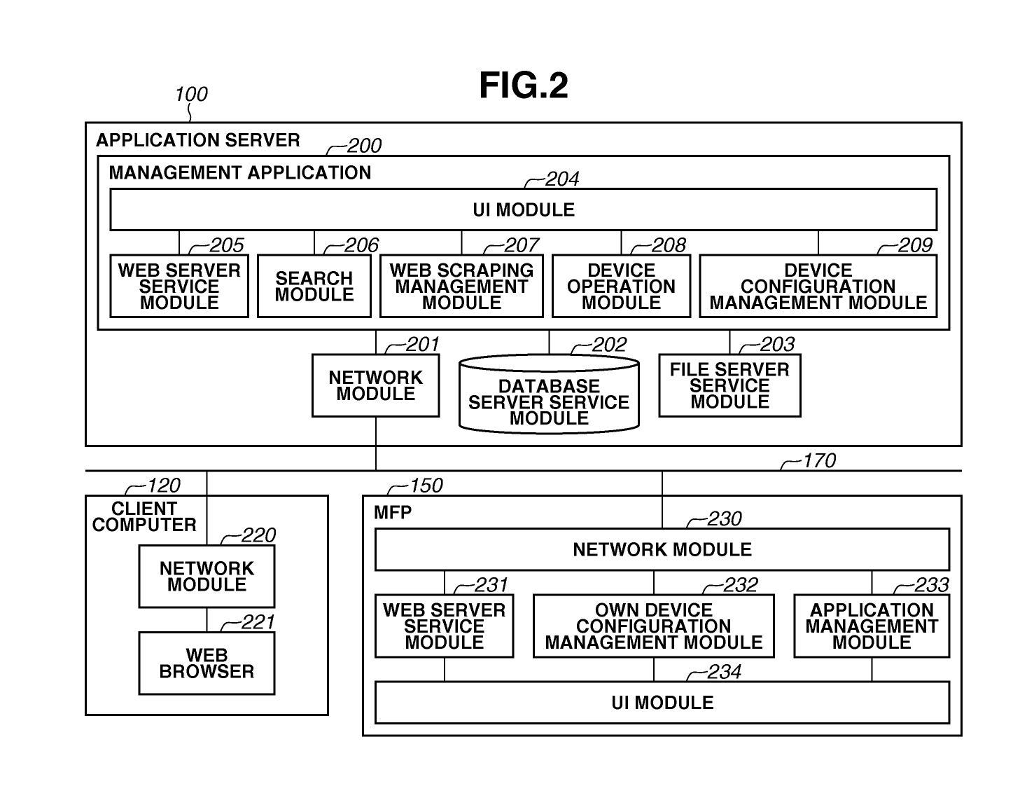

FIG. 2 is a block diagram illustrating an example of a software configuration of the network system including the management apparatus according to the exemplary embodiment of the present invention.

First, a software configuration of the application server 100 is described.

The application server 100 includes a management application 200 and modules 201 to 203, which exist as files stored in the external memory 111 of the application server 100. The management application 200 and the modules 201 to 203 are program modules that are loaded on the RAM 102 and executed by the OS executed by the CPU 101 or a module using the executed module and provide functions to the application server 100. The management application 200 can be added to the HD of the external memory 111 via a compact disc (CD)-ROM (not illustrated) for the external memory 111 or via the network 170.

The network module 201 performs network communications with the client computer 120 and the MFP 150 using an arbitrary communication protocol.

The management application 200 manages the MFP 150, which is connected to the application server 100 via the network 170. The management application 200 is implemented, for example, as a program for performing processing in response to a request to a web page provided by a web server service module 205 (to be described below). As described above, the management application 200 serves as a web application that manages the MFP 150, in conjunction with the web server service module 205.

The management application 200 includes the web server service module 205, which provides a service to send a HyperText Transfer Protocol (HTTP) response in response to the receipt of an HTTP request from a web browser 221 of the client computer 120. Examples of the HTTP response to be sent may include requesting a UI module 204 (to be described below) to generate an HTTP response or sending web page data stored in the external memory 111.

The UI module 204 generates an HTTP response in response to a request from the web server service module 205. Furthermore, the UI module 204 receives user input information transmitted from the web browser 221 of the client computer 120, and invokes each module as appropriate. Examples of the modules to be invoked by the UI module 204 include the web server service module 205, a search module 206, a web scraping management module 207, a device operation module 208, and a device configuration management module 209. Furthermore, the UI module 204 may invoke modules other than the above-mentioned modules.

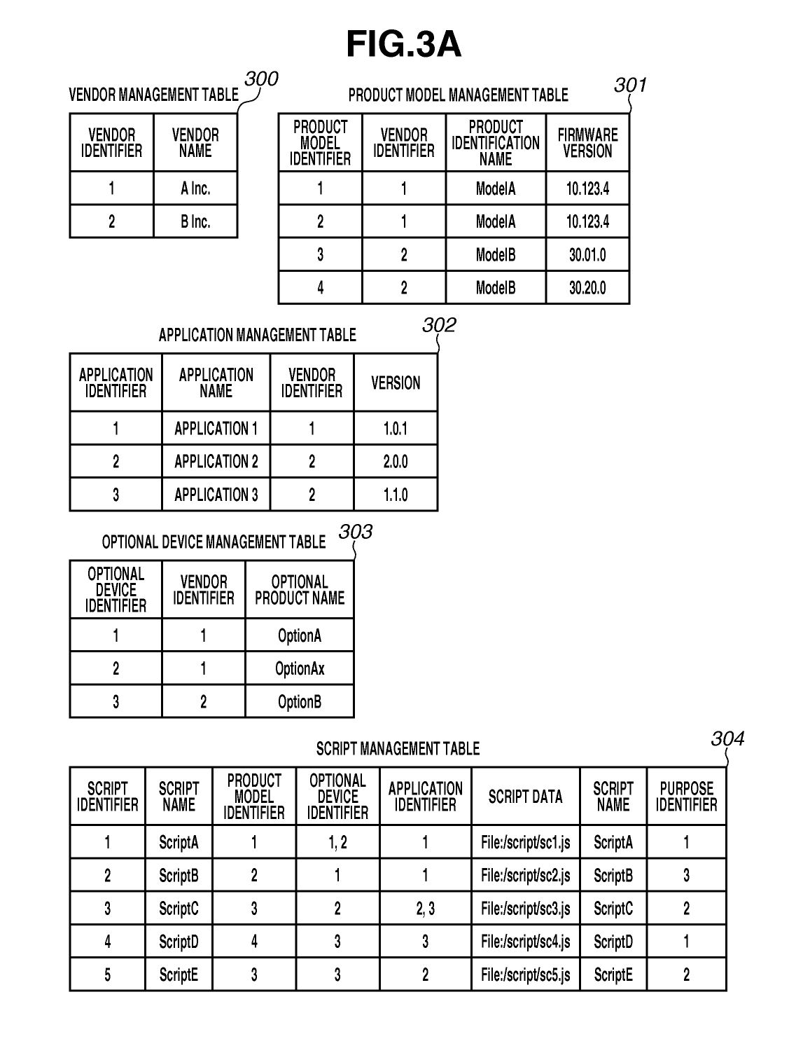

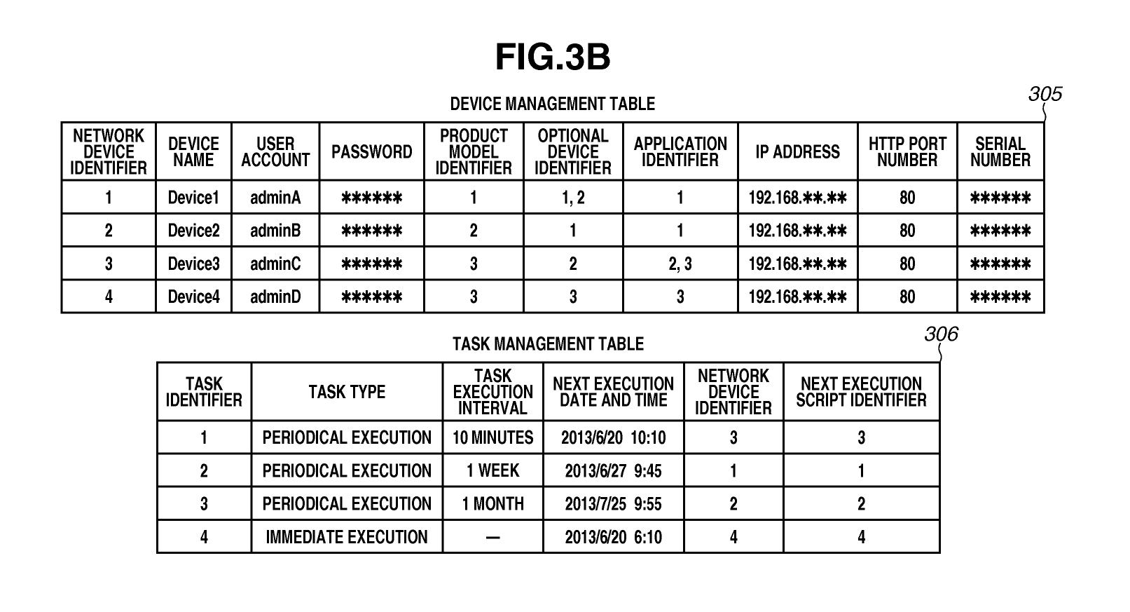

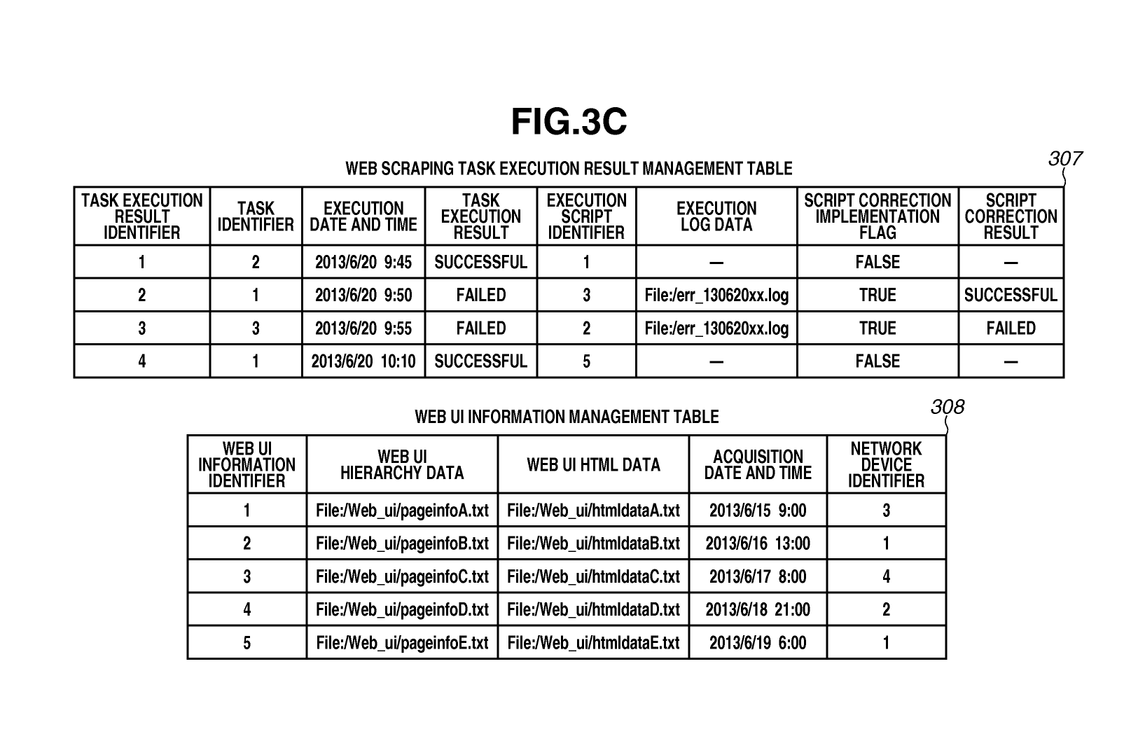

The search module 206 searches for an MFP 150 that is connected to the application server 100 via the network 170, by the use of an arbitrary communication protocol. Examples of the communication protocol to be used for search by the search module 206 include Simple Network Management Protocol (SNMP) and Service Location Protocol (SLP). Furthermore, the search module 206 may use another communication protocol such as Web Service Dynamic Discovery (WS-Discovery). After finding the MFP 150, the search module 206 acquires device information from the MFP 150 and stores the acquired device information into a device management table 305 (FIG. 3B) of a database server service module 202, which is described below.

The web scraping management module 207 can make an HTTP request to the MFP 150 via the network 170 and transmit arbitrary data to the MFP 150. Furthermore, the web scraping management module 207 can receive an HTTP response generated by a web server service module 231 of the MFP 150 and analyze an HTML description thereof to extract particular information.

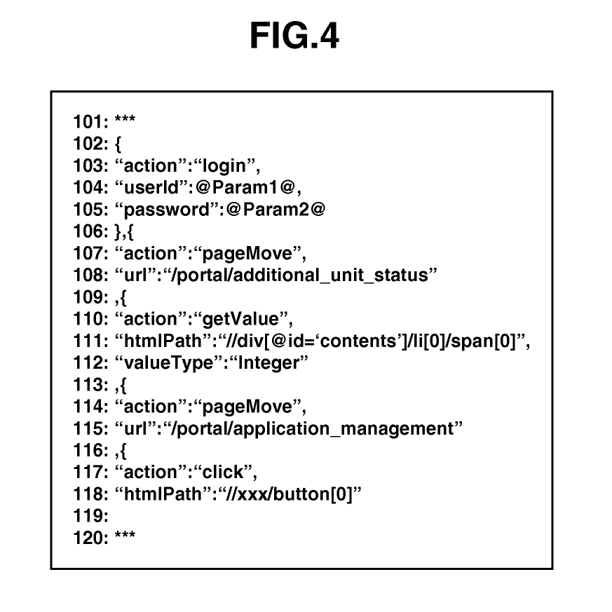

Moreover, the web scraping management module 207 acquires task information from a task management table 306 (FIG. 3B) of the database server service module 202, which is described below, and acquires, based on the task information, a script (an example of which is illustrated in FIG. 4) stored in the database server service module 202 or a file server service module 203, which is described below. Furthermore, the web scraping management module 207 can read the acquired script and operate a web UI, which is provided by the web server service module 231 of the MFP 150, according to an instruction described in the script. Examples of the operation on the web UI include web page transition specified by Uniform Resource Locator (URL), a keyboard input or mouse click operation on an input form, and searching the HTML description for particular character strings, comparing the character strings, and extracting particular information.

FIG. 4 illustrates an example of a script according to the present exemplary embodiment.

In the example of the script illustrated in FIG. 4, the above-mentioned operation instruction is described in the JavaScript Object Notation (JSON) format. The operation instruction may also be described in another description format such as Extensible Markup Language (XML). The web scraping management module 207 can read the description of a script such as that illustrated in FIG. 4 and perform a web UI operation. The script may allow a waiting time between operations to be specified and allow operations to be performed at arbitrary timing.

The device operation module 208 performs a setting change operation on the MFP 150 based on an input from the user. Examples of the setting change operation include an operation of updating firmware of the MFP 150, an operation of installing or uninstalling an application on or from the MFP 150, and an operation of disabling or enabling various functions included in a device. As a matter of course, the setting change operation may be other than the above-mentioned operations as long as it is an operation of changing settings of the MFP 150.

In addition, the above-mentioned processing operations for updating firmware and for installing or uninstalling an application may be executed as task processing with the execution date and time specified. In this case, the device operation module 208 acquires task information from an application management table 302 (FIG. 3A) of the database server service module 202, which is described below, and an application install task management table (not illustrated). Furthermore, it is supposed that data required for updating firmware and for installing an application is stored in a file server service module 203, which is described below.

The file server service module 203 manages files and stores and fetches a file in response to a request from another module. The file server service module 203 may be located on a separate device from the application server 100 as long as it is accessible from the management application 200. In this case, the file server service module 203 may transmit or receive a file using a protocol such as the File Transfer Protocol (FTP) or the Web-based Distributed Authoring and Versioning (WebDAV).

The database server service module 202 manages data and stores and fetches data in response to a request from another module. The database server service module 202 may be located on a separate device from the application server 100 as long as it is accessible from the management application 200.

The device configuration management module 209 manages configuration information of the MFP 150. Examples of the configuration information of the MFP 150 include the product name or vendor information of the MFP 150, version information of the firmware of the MFP 150, the identification name or version information of an application installed on the MFP 150, and the product name or vendor information of an optional device connected to the MFP 150. The configuration information of the MFP 150 may be other configuration information as long as it is information about hardware and software constituting the MFP 150.

Furthermore, the configuration information of the MFP 150 is stored in a vendor management table 300, a product model management table 301, an application management table 302, an optional device management table 303, and the device management table 305 such as those illustrated in FIGS. 3A and 3B, which are described below. The device configuration management module 209 reads and writes such table information to manage the configuration information of the MFP 150.

FIGS. 3A, 3B, and 3C illustrate examples of table configurations contained in the database server service module 202. The table configurations illustrated in FIGS. 3A, 3B, and 3C are mere examples, and may be different from the examples.

The vendor management table 300 is used to manage vendor information, such as the manufacturing vendor name of the MFP 150, which is managed by the management application 200. Examples of the vendor information managed with the vendor management table 300 include a vendor identifier and a vendor name. In the vendor management table 300, the vendor identifier is an identifier used to uniquely identify the vendor. Furthermore, vendor information of an optional device connected to the MFP 150 and vendor information of an application installed on the MFP 150 can be managed with the same vendor management table 300. In addition, respective dedicated vendor management tables for an MFP, an optional device, and an application may be created.

The product model management table 301 is used to manage product information of the MFP 150, which is managed by the management application 200. Examples of the product information managed with the product model management table 301 include a product model identifier, a vendor identifier, a product identification name, and firmware version. The product model identifier is an identifier used to uniquely identify the product model.

The application management table 302 is used to manage information about applications installed on the MFP 150, which is managed by the device configuration management module 209. Examples of the information managed with the application management table 302 include an application identifier, an application name, a vendor identifier, and version. In the application management table 302, the application identifier is an identifier used to uniquely identify an application. Furthermore, the vendor identifier indicates a vendor identifier set forth in the vendor management table 300 to associate the vendor information.

The optional device management table 303 is used to manage information about an optional device connected to the MFP 150, which is managed by the device configuration management module 209. Examples of the information managed with the optional device management table 303 include an optional device identifier, a vendor identifier, and an optional product name. In the optional device management table 303, the optional device identifier is an identifier used to uniquely identify the optional device. Furthermore, the vendor identifier indicates a vendor identifier set forth in the vendor management table 300 to associate the vendor information.

A script management table 304 is used to manage scripts describing operation instructions for executing web scraping with respect to the MFP 150, which is managed by the web scraping management module 207. Examples of information managed with the script management table 304 include a script identifier, a script name, a product model identifier, an optional device identifier, an application identifier, script data, and a purpose identifier.

In the script management table 304, the script identifier is an identifier used to uniquely identify the script. The product model identifier indicates a product model identifier set forth in the product model management table 301 to associate the model information of the MFP 150. The optional device identifier indicates an optional device identifier set forth in the optional device management table 303 to associate information of the optional device connected to the MFP 150. The application identifier indicates an application identifier set forth in the application management table 302 to associate information of the application installed on the MFP 150.

The script data is information indicating a path on the file server service module 203 in which the file substance of a script (such as that illustrated in FIG. 4) is stored. Furthermore, a script file may be stored in a database in the binary data format. Furthermore, it is supposed that various scripts can be managed with a database and do not need to be managed in a single binary data format.

The purpose identifier is used to uniquely identify the purpose of a script. Examples of the purpose of a script include changing of settings of the MFP 150, installing of an application or a license file on the MFP 150, and acquiring the status of the MFP 150. In addition, it is supposed that the purpose of a script is, for example, categorized and registered at the time of registration of the script.

It is supposed that, with the script management table 304, information about configuration conditions, such as a network device, an optional device connected to the network device, and an installed application, and script data and a purpose identifier corresponding to each configuration condition are registered in advance. In addition, the purpose of a script may be determined based on the description of the script as appropriate, rather than registering the purpose identifier with the script management table 304. For example, the purpose of a script can be determined at required timing based on information described in the script, such as a page transition flow, a file to be handled, and a storage location of the acquired data.

The device management table 305 is used to manage information about the MFP 150, which is managed by the management application 200. Examples of the information managed with the device management table 305 include a network device identifier, a device name, a user account, a password, a product model identifier, an optional device identifier, an application identifier, an IP address, an HTTP port number, a serial number, and date and time of final search (not illustrated).

In the device management table 305, the network device identifier is an identifier used to uniquely identify the MFP 150. The product model identifier indicates a product model identifier set forth in the product model management table 301 to associate the model information of the MFP 150. The user account is login information required for user authentication with respect to the MFP 150, which is the name of a user who can log into the MFP 150. Furthermore, the password is also used for user authentication.

The optional device identifier is an optional device identifier set forth in the optional device management table 303 to associate information of the optional device connected to the MFP 150. The application identifier indicates an application identifier set forth in the application management table 302 to associate information of the application installed on the MFP 150. The date and time of final search (not illustrated) is information of the last date and time the management application 200 searched for the MFP 150.

The task management table 306 is used to manage task information, which is used for the web scraping management module 207 to execute web scraping with respect to the MFP 150. Examples of the task information managed with the task management table 306 include a task identifier, a task type, a task execution interval, next execution date and time, a network device identifier, and a next execution script identifier.

In the task management table 306, the task identifier is used to uniquely identify the task. The task model specifies a task execution period. Examples of the task model include a type that periodically executes a task at intervals of a predetermined time or for every year, every month, or every week, and a type that executes a task only once at the specified date and time. The task execution interval specifies an execution interval of a task in the periodical execution. The next execution date and time specifies the date and time of a scheduled next task execution, at which the task is to be executed. The network device identifier indicates a network device identifier set forth in the device management table 305 to associate a particular MFP 150. The task is executed with respect to the associated MFP 150. The next execution script identifier indicates a script identifier set forth in the script management table 304 to associate a script to be used at the time of next execution.

An execution result management table 307 is used to manage information of a task execution result obtained when the web scraping management module 207 has executed a web scraping task with respect to the MFP 150. Examples of the information managed with the execution result management table 307 include a task execution result identifier, a task identifier, execution date and time, a task execution result, an execution script identifier, execution log data, a script correction implementation flag, and a script correction result.

In the execution result management table 307, the task execution result identifier is used to uniquely identify a task execution result. The task identifier indicates a task identifier set forth in the task management table 306 to associate task information used for execution of web scraping. The execution script identifier indicates a script identifier set forth in the script management table 304 to associate a script used at the time of task execution.

The execution log data is a log file to be output at the time of execution of web scraping, and, here, indicates a path on the file server service module 203 in which the log file is stored. Examples of log information to be output to the log file include network device information, web UI page transition information, HTML information, an execution result of each command, various parameters, and script execution error information. The log file may be managed not in the file format but on a database, and the log file may be stored on a database in the binary data format. In addition, various pieces of log data can be managed on a database and do not need to be managed in a single binary data format.

A web UI information management table 308 is used to manage page configuration information (web UI information) of a web page. More specifically, the web UI information management table 308 is used to manage web UI information (page hierarchy information of a web UI and HTML information of each page) which the web scraping management module 207 has acquired by accessing the web UI of the MFP 150. Examples of the information (web UI information) managed with the web UI information management table 308 include a web UI information identifier, web UI hierarchy data, web UI HTML data, acquisition date and time, and a network device identifier.

In the web UI information management table 308, the web UI information identifier is used to uniquely identify web UI information. The web UI hierarchy data is data indicating hierarchy information of a web UI page. The web UI HTML data is data indicating HTML information of the web UI page. The acquisition date and time indicates the date and time the web UI information has been acquired. The network device identifier indicates a network device identifier set forth in the device management table 305 to associate a particular MFP 150.

In addition, if new web UI information has been acquired by the web scraping management module 207, a new record is added to the web UI information management table 308, and the acquired web UI information is stored in the new record. In this way, the web UI information management table 308 is usable to manage history of web UI information of a network device.

Next, the software configuration of the client computer 120 is described with reference to FIG. 2. Each module constituting the client computer 120 is a program module existing as a file stored in the ROM 103 or the external memory 111. The program module is then loaded and executed on the RAM 102 by an OS executed by the CPU 101 of the client computer 120 or a module using the program module, thus providing functions to the client computer 120.

A network module 220 performs network communications with the application server 100 and the MFP 150 using an arbitrary communication protocol. The web browser 221 transmits an HTTP request via the network module 220, and receives and displays an HTTP response message. The web browser 221 is used for the client computer 120 to access the application server 100.

Next, the software configuration of the MFP 150 is described.

In the MFP 150, various modules exist as files stored in the ROM 154 or the external memory 162, and are loaded and executed on the RAM 153 by the CPU 152, thus providing functions to the MFP 150.

A network module 230 performs network communications with the application server 100 and the client computer 120 using an arbitrary communication protocol.

The web server service module 231 receives HTTP requests from the web scraping management module 207 of the management application 200 and the web browser 221 of the client computer 120, and sends HTTP responses in response to the HTTP requests. The HTTP response to be sent may be, for example, web page data stored in the external memory 162, or the web server service module 231 may request the UI module 204 of the management application 200 to generate an HTTP response.

An own device configuration management module 232 manages hardware configuration information of the MFP 150. Examples of the hardware configuration information include own device unique information, such as the serial number or manufacturing location of the own device, and product information or use status of an optional device connected to the MFP 150. Examples of the optional device include a finisher and a cassette unit. In a case where components subject to consumption or abrasion, such as toner and a hinge, are used inside an optional device, the own device configuration management module 232 also acquires the consumption state and abrasion state of the components and notifies the management application 200 of the acquired states via the network module 230 and the network 170.

Furthermore, the own device configuration management module 232 receives a firmware update request transmitted from the device operation module 208 of the management application 200. Alternatively, the own device configuration management module 232 receives an application install request via the network module 230. Then, the own device configuration management module 232 performs updating of firmware of the own device or installing of an application on the MFP 150.

An application management module 233 manages software configuration information of the MFP 150. Examples of the software configuration information include information about firmware of the MFP 150 and information about installed applications.

A UI module 234 draws a UI to be displayed on the operation unit 156 of the MFP 150 and receives user input values input by the UI operation of the user on the operation unit 156.

As described above, the management application 200 of the application server 100, which serves as a management apparatus, scrapes operation contents of a work (acquisition of device information or changing of settings) performed via a web page provided by a web server of the MFP 150 (device), which serves as a network device, thus enabling management of the device without using a unique protocol of the device vendor or environmental settings thereof. The management application 200 writes, on a script, procedures of a browser operation instruction for each operation on a web page provided by the web server of the device, and manages the script separately for each device.

In addition, the above-mentioned script may become unexecutable if the web UI configuration has changed due to changing of the configuration of the MFP 150. In this case, there may be considered a case where it becomes impossible to continue to manage the MFP 150 the configuration of which has been changed. For example, a case where the page hierarchy of a web UI or HTML information of each page is changed by the function addition caused by the firmware update of the MFP 150 is considered. Therefore, various commands described in the script associated with the MFP 150 may be partially or wholly disabled, thus resulting in a failure of the task. This makes it impossible to continue to manage the MFP 150. However, the management application 200 has a configuration capable of continuing to manage the MFP 150 even if a configuration change or the like occurs in the MFP 150. The management application 200 has such a configuration as to appropriately update the managed script according to a change of a web page due to the firmware update or option change of a device. Hereinafter, the details of such a configuration are described.

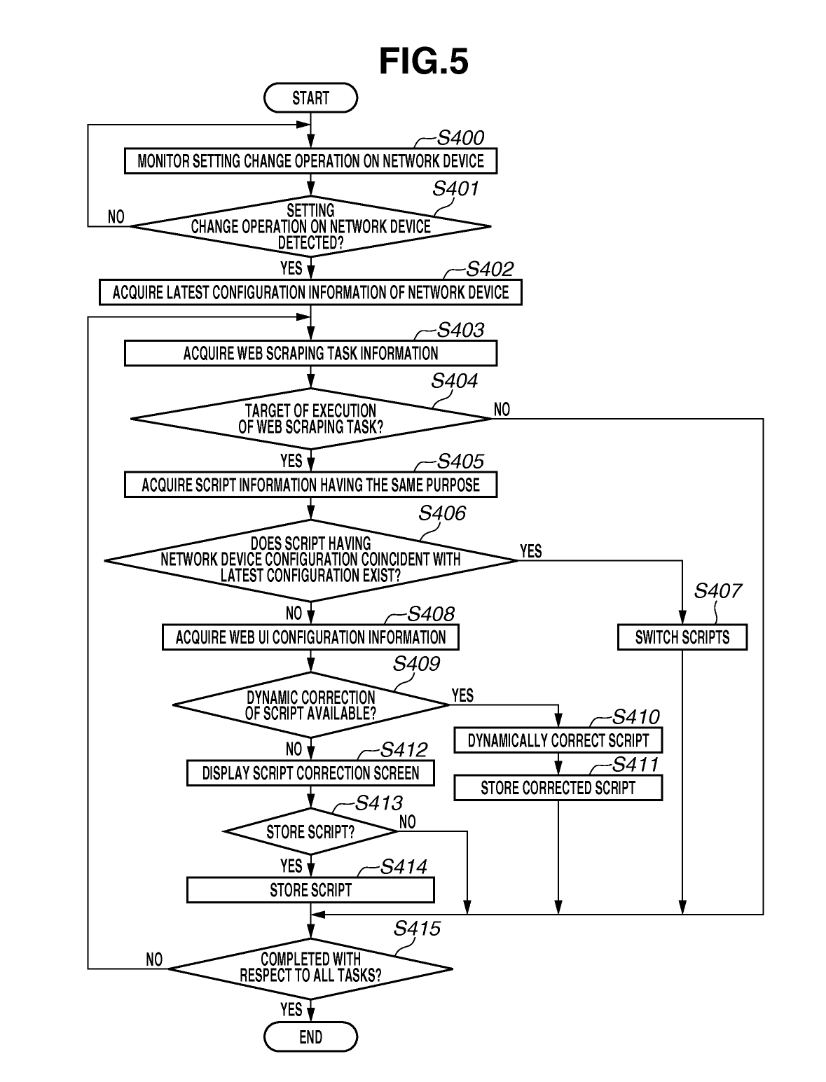

The following describes, with reference to FIG. 5, an operation in which the application server 100 detects that the settings of a network device have been changed and corrects a script dynamically according to configuration statuses of hardware and software of the MFP 150.

FIG. 5 is a flowchart illustrating an example of an operation of the application server 100 according to a first exemplary embodiment. Processing illustrated in the flowchart of FIG. 5 is executed by the application server 100. More specifically, the processing is implemented by the CPU 101 of the application server 100 reading and executing a program stored in the external memory 111.

In step S400, the device operation module 208 of the management application 200 monitors a setting change operation on a network device, which is performed in response to a user input. Examples of the setting change operation include an operation of updating firmware of the MFP 150 via the management application 200, an operation of uninstalling an application of the MFP 150, and an operation of changing other various setting values. As a matter of course, the setting change operation may be other than the above-mentioned operations as long as it is an operation of changing settings of the MFP 150 in response to a user input.

Next, in step S401, the management application 200 determines, based on a result of monitoring in step S400, whether the setting change operation has been performed in response to a user input (whether the setting change operation has been detected). If the management application 200 determines that the setting change operation has not been performed (NO in step S401), the processing returns to step S400, in which the management application 200 continues to monitor a setting change operation performed by a user input. On the other hand, if the management application 200 determines that the setting change operation has been performed (YES in step S401), the processing proceeds to step S402.

In step S402, the device configuration management module 209 acquires, from the device management table 305 of the database server service module 202, the latest configuration information of an MFP 150 (hereinafter referred to as a “target MFP”) on which it is determined in step S401 that the setting change operation has been performed.

Next, in step S403, the web scraping management module 207 acquires, from the task management table 306 of the database server service module 202, one piece of task information that has not yet been subjected to a process in step S404 and subsequent steps.

In step S404, the web scraping management module 207 determines, based on contents of the task information acquired in step S403, whether the target MFP is a target of execution of a web scraping task corresponding to the task information. In particular, the web scraping management module 207 makes the determination by comparing a network device identifier included in the task information acquired in step S403 with the network device identifier of the target MFP.

If the web scraping management module 207 determines that the target MFP is not a target of execution of a web scraping task corresponding to the task information acquired in step S403 (NO in step S404), the management application 200 causes the processing to directly proceed to step S415. On the other hand, if the web scraping management module 207 determines that the target MFP is a target of execution of a web scraping task corresponding to the task information acquired in step S403 (YES in step S404), the management application 200 causes the processing to proceed to step S405.

In step S405, the web scraping management module 207 acquires, based on a next execution script identifier included in the task information acquired in step S403, network device configuration condition information and script information about a script corresponding to the next execution script identifier and a script having the same purpose identifier as that of the former script from the script management table 304 of the database server service module 202. The network device configuration condition information indicates a product model identifier, an optional device identifier, an application identifier, etc., included in the script management table 304. Additionally, in a case where no purpose identifier is registered with the script management table 304, the web scraping management module 207 may determine the purpose of a script based on a description of each script. For example, the web scraping management module 207 can determine the purpose at required timing based on a page transition flow, a file to be handled, and a storage location of the acquired data, which are described in the script.

Next, in step S406, the web scraping management module 207 determines whether there exists a script having the network device configuration condition information, acquired in step S405, coincident with the latest configuration information of the target MFP acquired in step S402. If the web scraping management module 207 determines that there exists a script having the network device configuration condition information coincident with the latest configuration information (YES in step S406), the processing proceeds to step S407.

In step S407, the web scraping management module 207 rewrites the next execution script identifier of the task information, acquired in step S403, included in the task management table 306 to the script identifier of the script determined in step S406 to have the network device configuration condition information coincident with the latest configuration information. Then, the processing proceeds to step S415. This enables the web scraping management module 207 to read a script corresponding to the page hierarchy and HTML information of each page of a web UI changed by the current configuration of the target MFP at the time of a next task execution and to perform web scraping.

On the other hand, if the web scraping management module 207 determines that there exists no script having the network device configuration condition information coincident with the latest configuration information (NO in step S406), the processing proceeds to step S408.

In step S408, the web scraping management module 207 accesses the web UI of the target MFP and acquires web UI configuration information (page hierarchy information of a web UI and HTML information of each page) by using the following method.

First, the web scraping management module 207 acquires address information of the target MFP from the device management table 305, and makes an HTTP request to the web server service module 231 of the target MFP. Next, the web scraping management module 207 sets the page URL of an HTTP response, received from the web server service module 231 of the target MFP, as the top page, acquires URL to another page included in HTML information of the top page with the use of a link tag of HTML information or regular expression search of URL, and acquires hierarchy information of each page based on a character string difference of each URL. Then, the web scraping management module 207 progressively makes an HTTP request to the acquired URLs and recursively performs the above-described processing on each page, thus acquiring page hierarchy information of the web UI and HTML information of each page. Furthermore, there is another method of acquiring page hierarchy information of the web UI and HTML information of each page by using a site map file provided by the web server service module 231 of the target MFP. In that case, the web scraping management module 207 can acquire the site map file and recursively acquire HTML information of each page based on information of the site map file. As a matter of course, the web scraping management module 207 can acquire page hierarchy information of the web UI and HTML information of each page by using other methods. In addition, it is supposed that the web UI configuration information acquired in step S408 is added to the web UI information management table 308.

Next, in step S409, the web scraping management module 207 determines whether the dynamic correction of the script is available, based on the page hierarchy information of a web UI and HTML information of each page acquired in step S408.

As a method for determining whether the dynamic correction of the script is available, for example, the web scraping management module 207 acquires page hierarchy information obtained before the configuration of the target MFP is changed, from the web UI information management table 308 of the database server service module 202. Next, the web scraping management module 207 makes a comparison in hierarchical tree between the acquired page hierarchy information and the latest web UI page hierarchy information acquired in step S408. With this method, when a page targeted for web scraping has moved to another URL hierarchical layer, the web scraping management module 207 can determine to which layer the page has moved. Furthermore, in a similar way, the web scraping management module 207 can determine which element has been changed in the HTML information by comparing HTML information of each page with the previous HTML information. For example, the web scraping management module 207 can convert HTML information of each page into a Document Object Model (DOM) tree and extract each difference in attribute values, such as location information, tag name, and ID, and a value enclosed by tags in each DOM element. Thus, even if a particular DOM element has been moved to inside a different element, the web scraping management module 207 can determine to which location in the HTML information the particular DOM element has moved. Then, when having successfully determined the movement of the URL hierarchical layer and the change of an element of the HTML information, the web scraping management module 207 determines that the dynamic correction of the script is available. When having failed to determine those, the web scraping management module 207 determines that the dynamic correction of the script is unavailable. As a matter of course, the web scraping management module 207 may determine whether the dynamic correction of the script is available by using methods other than the above-described method.

If the web scraping management module 207 determines that the dynamic correction of the script is available (YES in step S409), the processing proceeds to step S410.

In step S410, the web scraping management module 207 acquires script data from the script management table 304 of the database server service module 202 or from the file server service module 203, and corrects the script. Examples of the correction of a script include correcting a URL character string in the script or a path character string indicative of an element position of the HTML information based on difference information obtained from page hierarchy information and HTML information of a web UI. When the web scraping management module 207 has completed the correction of the script, the processing proceeds to step S411.

In step S411, the web scraping management module 207 stores the corrected script, by overwrite save, into the script management table 304 of the database server service module 202 or into the file server service module 203. As a matter of course, the web scraping management module 207 may store the corrected script by save as a new file, for example, add new script information to the script management table 304. When the web scraping management module 207 has completely stored the corrected script, the processing proceeds to step S415.

If, in step S409, the web scraping management module 207 determines that the dynamic correction of the script is unavailable (NO in step S409), the processing proceeds to step S412.

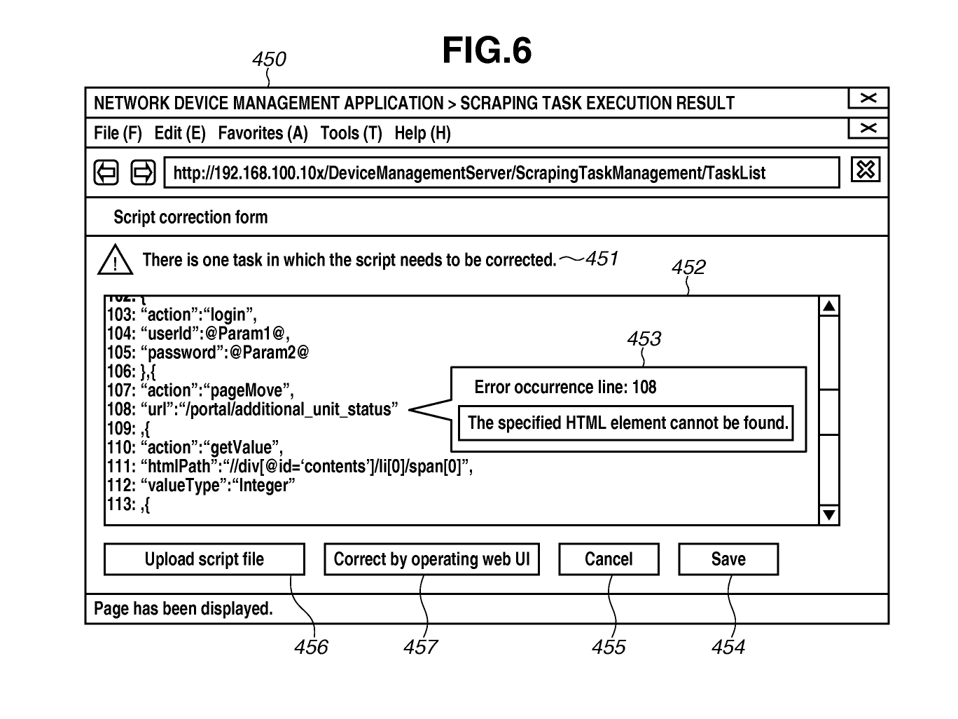

In step S412, the web scraping management module 207 acquires task information from the task management table 306 or the execution result management table 307 of the database server service module 202, and then displays a script correction screen, such as that illustrated in FIG. 6, on the web browser 221 (a client screen) of the client computer 120 via which the setting change operation detected in step S401 was performed.

FIG. 6 illustrates an example of the script correction screen according to the present exemplary embodiment.

Referring to FIG. 6, the script correction screen is displayed on a web browser screen 450. A message display region 451 displays a message indicating that the script needs to be corrected. A text editing region 452 outputs contents of the script in advance. An error message display region 453 for the script is displayed in a pop-up window at an error occurrence location within the script. An error message displayed with the error message display region 453 includes information about the position in which the script needs to be corrected, a message or figure indicating how to correct the script, and a link used to transition to various web pages, such as error log information. In addition, the error message may be displayed by using other methods such as with another page or another frame.

When a save button 454 for a script is clicked, the web scraping management module 207 is notified of a notice indicating the clicking of the save button 454. In response to the notice, the web scraping management module 207 stores the input state of the text editing region 452, and then the processing proceeds to step S413.

When a cancel button 455 is clicked, the web scraping management module 207 is notified of a notice indicating the clicking of the cancel button 455. In response to the notice, the web scraping management module 207 cancels the correction processing of the script, and then the processing proceeds to step S415. As a matter of course, the web scraping management module 207 may temporarily store the input state of the text editing region 452 to enable displaying the script correction screen later again and resuming the correction of the script.

When an upload button 456 for a script file is clicked, a file selection screen is displayed to enable a text file in which the script is described to be uploaded. When uploading of the text file is performed, the web scraping management module 207 temporarily stores the uploaded script data into the file server service module 203, and then the processing proceeds to step S413.

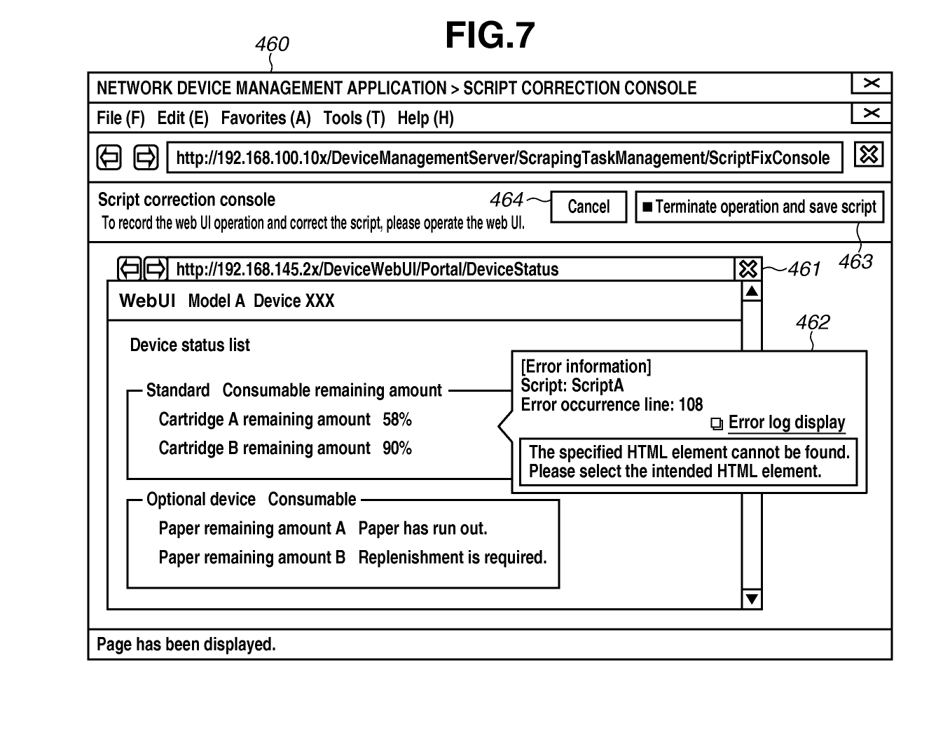

When a transition button 457 used for transition to a web UI operation screen (FIG. 7) of the target MFP, which is described below, is clicked, the web UI operation screen (FIG. 7) is displayed.

The script correction screen has been described above with reference to FIG. 6.

Next, the web UI operation screen is described with reference to FIG. 7.

FIG. 7 illustrates an example of the web UI operation screen of the target MFP, which is displayed on the web browser screen when the transition button 457 illustrated in FIG. 6 is clicked.

When the web UI operation screen illustrated in FIG. 7 is displayed, the web browser records a web UI operation on the target MFP, which is performed by the user, and the script is corrected based information about the recorded web UI operation. For example, the web scraping management module 207 displays, to the user, a portion at which the dynamic correction of the script has failed as an error message, reads the script partially up to the correction-failed portion, and performs web scraping while displaying the course of page transition to the user. After that, the web scraping management module 207 allows the user to perform an input operation on the web UI operation screen, and then the web browser records the input operation.

Examples of the input operation include a keyboard input, a mouse click operation, a file upload operation, and a character string selection. The web browser asynchronously transmits such input operation information to the application server 100, and the web scraping management module 207 corrects the script based on the input operation information. In this instance, the input operation information may not be transmitted to the application server 100, and a program that operates in association with the web browser using an applet or the like may dynamically correct the script.

Referring to FIG. 7, the web UI operation screen is displayed on a web browser screen 460. A web UI screen 461 displays a web UI of the target MFP inside the web browser screen 460. The web UI screen 461 for the target MFP displays a web UI of the target MFP using an in-line frame element of HTML and a script language usable by a web browser, such as JavaScript (registered trademark). In addition, the web UI screen 461 for the MFP 150 may be displayed on another window, and may be subjected to display processing or operation recording processing by the use of an applet of the web browser. Examples of the applet include Adobe Flash (registered trademark), Microsoft Silverlight (registered trademark), Microsoft DirectX (registered trademark), and JavaApplet (registered trademark). As a matter of course, other methods may be used to display a web UI of the target MFP and to record various input operations.

In an error message display region 462 for a script, a message indicative of an error occurrence location of the script is displayed in a pop-up window at an error-related location inside the web UI. The error message display region 462 is similar to the error message display region 453 illustrated in FIG. 6, and the detailed description thereof is, therefore, omitted. When a button 463, which is used to terminate a web UI operation on the target MFP and save the script, is clicked, the web scraping management module 207 is notified of a notice indicating the clicking of the button 463. In response to the notice, the web scraping management module 207 causes the processing to proceed to step S413.

When a cancel button 464 is clicked, the web scraping management module 207 is notified of a notice indicating the clicking of the cancel button 464. In response to the notice, the web scraping management module 207 cancels the correction processing of the script, and then the processing proceeds to step S415.

The web UI operation screen has been described above with reference to FIG. 7.

The description now refers back to the flowchart of FIG. 5.

In step S413, the web scraping management module 207 determines whether to store the script based on contents of the script information and the web UI operation information on the target MFP, which are acquired via the script correction screen illustrated in FIG. 6 and the web UI operation screen for the target MFP illustrated in FIG. 7.

For example, the web scraping management module 207 determines whether web scraping is executable based on contents of the acquired script information. If the web scraping management module 207 determines that web scraping is not executable, the web scraping management module 207 determines not to store the script data (NO in step S413), and the processing proceeds to step S415. In addition, if the determination in step S413 is NO, the processing may return to step S412, in which the web scraping management module 207 displays the script correction screen again.

On the other hand, if the web scraping management module 207 determines that web scraping is executable based on contents of the acquired script information, the web scraping management module 207 determines to store the script data (YES in step S413), and the processing proceeds to step S414.

In step S414, the web scraping management module 207 stores the script, corrected via the screens illustrated in FIGS. 6 and 7, into the script management table 304 of the database server service module 202 or into the file server service module 203. Then, the processing proceeds to step S415.

In step S415, the web scraping management module 207 determines whether a process in step S403 and subsequent steps has been completed with respect to all the pieces of task information included in the task management table 306. If the web scraping management module 207 determines that the process has not yet been completed (NO in step S415), the processing returns to step S403, in which the web scraping management module 207 acquires next task information that has not yet been subjected to the process.

On the other hand, if the web scraping management module 207 determines that the process in step S403 and subsequent steps has been completed with respect to all the pieces of task information (YES in step S415), the processing in the flowchart of FIG. 5 ends.

The above-described processing enables the management application 200, when detecting a setting change operation on the MFP 150 performed by the user, to dynamically correct a script or switch scripts according to the configuration of the MFP 150 changed by the setting change operation. As a result, the management application 200 becomes able to continue to execute web scraping even after the setting change of the MFP 150.

Accordingly, the management apparatus is able to continue to manage a network device even when the configuration of the network device has been changed.

In the above-described first exemplary embodiment, there has been described an arrangement of dynamically correcting a script according to the configuration of the MFP 150 when the setting change operation on the MFP 150 has been performed via the management application 200. A second exemplary embodiment describes an arrangement of acquiring latest configuration information of the MFP 150, detecting a change of the configuration, and dynamically correcting a script when the settings of the MFP 150 have been changed via an operation panel of the MFP 150 or an external application.

The system configuration, hardware configuration, and software configuration of a client server system according to the second exemplary embodiment are similar to those of the first exemplary embodiment illustrated in FIGS. 1, 2, and 3, and the description thereof is, therefore, omitted.

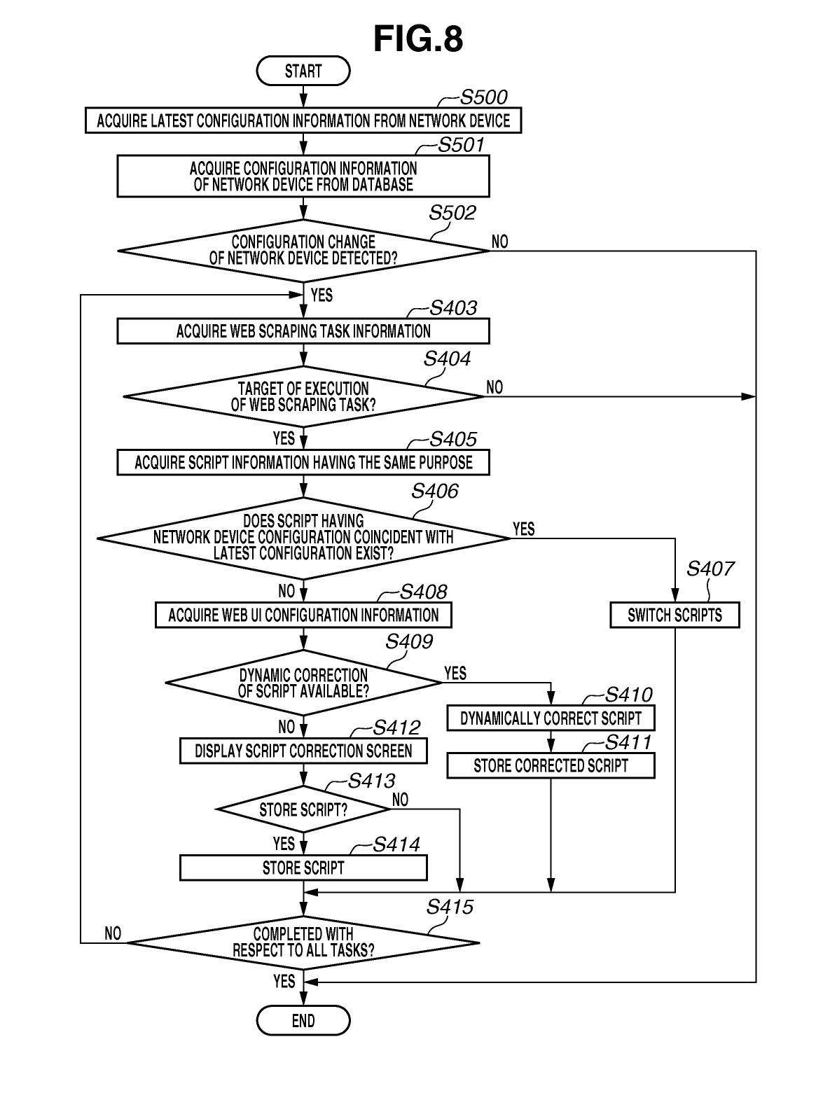

The following describes, with reference to FIG. 8, an operation of the application server 100 to acquire latest configuration information of the MFP 150, detect a change of the configuration, and dynamically correct a script. Steps similar to those of the first exemplary embodiment illustrated in FIG. 5 are omitted from the description.

FIG. 8 is a flowchart illustrating an example of the operation of the application server 100 according to the second exemplary embodiment. Processing illustrated in the flowchart of FIG. 8 is performed by the management application 200. Specifically, the processing is performed by the CPU 101 of the application server 100 reading and executing a program stored in the external memory 111 or the like. It is supposed that the processing illustrated in the flowchart of FIG. 8 is performed for each network device managed by the application server 100 (i.e., for each MFP 150). Hereinafter, an MFP 150 targeted for that processing is referred to as a “target MFP”.

First, in step S500, the device configuration management module 209 makes a configuration information acquisition request to the own device configuration management module 232 and the application management module 233 of the target MFP via the network 170, and acquires latest configuration information from the own device configuration management module 232 and the application management module 233. This processing is periodically performed as a task. As a matter of course, it may be performed on an arbitrary date and time.

Next, in step S501, the device configuration management module 209 acquires configuration information of the target MFP from the device management table 305 of the database server service module 202.

Next, in step S502, the device configuration management module 209 compares the latest configuration information of the target MFP acquired in step S500 with the configuration information of the target MFP acquired in step S501, and determines whether the configuration of the target MFP has been changed.

If the device configuration management module 209 determines that the configuration of the target MFP has been changed (YES in step S502), the web scraping management module 207 performs a process in step S403 and subsequent steps. The process in step S403 and subsequent steps is the same as that illustrated in FIG. 5, and the description thereof is, therefore, not repeated. However, in step S412 illustrated in FIG. 8, it is supposed that screens such as those illustrated in FIGS. 6 and 7 are displayed on all of web browsers of clients that connect to the application server 100 at this time. In addition, in a case where the availability of a setting change operation is set on a user account by user account basis, it is supposed that such screens are displayed on the web browser of a client who is logging in with a user account having a superior authority capable of performing a setting change. Furthermore, an e-mail prompting a previously-registered administrator to log in for script correction may be sent to the e-mail address of the administrator, and, when the administrator has logged in, the above-mentioned screens may be displayed.

On the other hand, if the device configuration management module 209 determines that the configuration of the target MFP has not been changed (NO in step S502), the device configuration management module 209 ends the processing in the flowchart of FIG. 8.

The above-described processing, which is performed as a periodical task for each MFP 150 managed by the management application 200, enables the management application 200 to detect a setting change of the MFP 150 and dynamically correct a script. As a result, even if the configuration of the MFP 150 has been changed without via the management application 200, the management application 200 becomes able to continue to execute a web scraping task even after the change of the configuration.

In the above-described first exemplary embodiment, there has been described an arrangement of dynamically correcting a script according to the configuration of the MFP 150 when the setting change operation on the MFP 150 has been performed via the management application 200. In the above-described second exemplary embodiment, there has been described an arrangement of detecting a configuration change of the MFP 150 and dynamically correcting a script even when the settings of the MFP 150 have been changed via the operation panel of the MFP 150 or an external application other than the management application 200. A third exemplary embodiment describes an arrangement of dynamically correcting a script if a web scraping task fails.

The system configuration, hardware configuration, and software configuration of a client server system according to the third exemplary embodiment are similar to those of the first exemplary embodiment illustrated in FIGS. 1, 2, and 3, and the description thereof is, therefore, omitted.

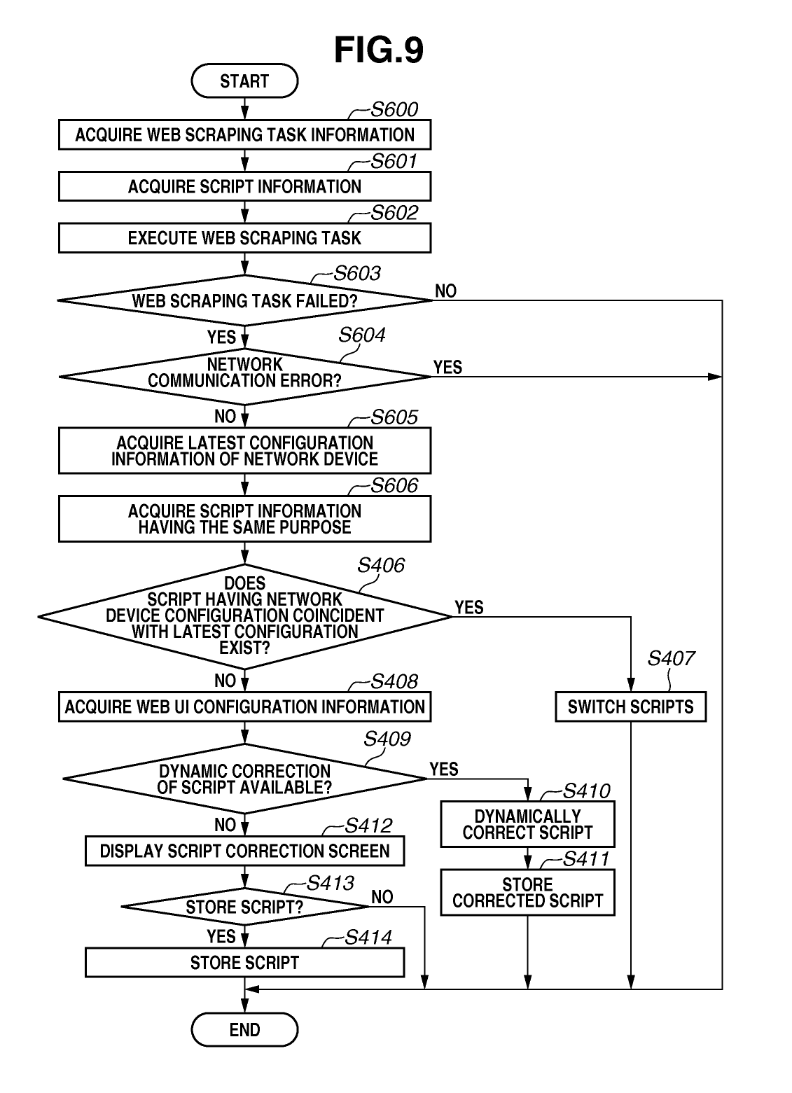

The following describes, with reference to FIG. 9, an operation of the application server 100 to detect a failure of the web scraping task and dynamically correct a script. Steps similar to those of the first exemplary embodiment illustrated in FIG. 5 are omitted from the description.

FIG. 9 is a flowchart illustrating an example of the operation of the application server 100 according to the third exemplary embodiment. Processing illustrated in the flowchart of FIG. 9 is performed by the management application 200. Specifically, the processing is performed by the CPU 101 of the application server 100 reading and executing a program stored in the external memory 111 or the like. It is supposed that the processing illustrated in the flowchart of FIG. 9 is performed when the application server 100 executes a task.

First, in step S600, the web scraping management module 207 acquires task information from the task management table 306 of the database server service module 202. Next, in step S601, the web scraping management module 207 acquires, from the script management table 304, script data corresponding to a next execution script identifier included in the task information acquired in step S600.

Next, in step S602, the web scraping management module 207 executes, according to a description of the script data acquired in step S601, web scraping processing on a web UI provided by the web server service module 231 of the MFP 150 targeted for the task acquired in step S601 (hereinafter referred to as a “target MFP”).

Next, in step S603, the web scraping management module 207 determines whether the web scraping processing executed in step S602 has failed. Examples of a method for determining whether the web scraping processing has failed include a method of determining whether various web UI operation commands described in the script have been executed to the last one. Specifically, examples of the failure include a case where a web UI page or an HTML element, which is targeted for operation in each command, cannot be found, a case where a communication of the MFP 150 to the web UI has interrupted, and a case where the login to the web UI cannot be performed due to a change of account information used for the login.

If the web scraping management module 207 determines that the web scraping processing has not failed (is successful) (NO in step S603), the web scraping management module 207 directly ends the processing in the flowchart of FIG. 9.

On the other hand, if the web scraping management module 207 determines that the web scraping processing has failed (YES in step S603), the processing proceeds to step S604.

In step S604, the web scraping management module 207 determines whether there is a problem with a network communication with the target MFP (i.e., the cause of failure of the web scraping processing in step S603 is a communication error). Examples of a method for determining whether there is a problem with a network communication (a communication error) include a method of making an HTTP request to the web server service module 231 of the target MFP and checking an HTTP response. As a matter of course, the examples include other checking methods.

If the web scraping management module 207 determines that there is a problem with a network communication with the target MFP (a communication error) (YES in step S604), the web scraping management module 207 directly ends the processing in the flowchart of FIG. 9. Additionally, in this instance, the management application 200 may display, on the UI screen of the management application 200, or notify a previously-registered e-mail address by e-mail of, a message to the user indicating that, since a problem occurred with a network communication, web scraping has failed.

On the other hand, if the web scraping management module 207 determines that there is no problem with a network communication with the target MFP (no communication error) (NO in step S604), the processing proceeds to step S605.

In step S605, the web scraping management module 207 instructs the device configuration management module 209 to make a configuration information acquisition request to the own device configuration management module 232 and the application management module 233 of the target MFP via the network 170, and acquires latest configuration information from the own device configuration management module 232 and the application management module 233. This processing is similar to that in step S500 illustrated in FIG. 8, and the details thereof are, therefore, omitted from the description.

Next, in step S606, the web scraping management module 207 acquires, based on a next execution script identifier included in the task information acquired in step S600, network device configuration condition information and script information about a script corresponding to the next execution script identifier and a script having the same purpose identifier as that of the former script from the script management table 304 of the database server service module 202. The network device configuration condition information indicates a product model identifier, an optional device identifier, an application identifier, etc., included in the script management table 304.

Next, the web scraping management module 207 performs a process in step S406 and subsequent steps. The process in step S406 and subsequent steps is the same as that illustrated in FIG. 5, and the description thereof is, therefore, not repeated. However, processing in step S412 illustrated in FIG. 9 is similar to that in step S412 illustrated in FIG. 8. Furthermore, after each of steps S407, S411, and S414 illustrated in FIG. 9, the web scraping management module 207 ends the processing in the flowchart of FIG. 9.

The above-described processing, which is performed as a periodical task, enables the management application 200 to detect a failure of the web scraping task and dynamically correct a script. As a result, even if the management application 200 has executed, with respect to the MFP 150 the configuration of which has been changed, a web scraping task before performing processing in the second exemplary embodiment, the management application 200 becomes able to continue to execute a web scraping task after that.

As described above, according to each of the first to third exemplary embodiment, even if the page hierarchy of the web UI and HTML information of each page have been changed due to a configuration change of a network device, the management apparatus can detect a configuration change of the network device and that of the web UI and dynamically switch scripts, thus continuing to execute a management task of the network device. In other words, even if the configuration of the network device has been changed, the management apparatus can continue to manage the network device without using a unique protocol of the vendor. Therefore, such a complicated work that the administrator manually corrects a script each time the web UI has changed can be reduced, so that the load on the administrator can be decreased.

In addition, the structure and contents of the above-described various pieces of data are not restrictive, and can naturally be changed or modified according to their applications and purposes.

While the exemplary embodiments have been described above, the present invention can be embodied in the form of, for example, a system, an apparatus, a method, a program, or a storage medium. Specifically, the present invention can apply to a system composed of a plurality of devices or to an apparatus composed of a single device.

Furthermore, an arrangement configured by combining the above-described exemplary embodiments can be included in the present invention.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-267432 filed Dec. 25, 2013, which is hereby incorporated by reference herein in its entirety.

What is claimed is:

1. A management apparatus comprising:
a management unit configured to manage, as a script, an instruction required for an operation on a network device and issued via a web page provided by the network device;
an execution unit configured to execute the operation on the network device via the web page provided by the network device by use of the script managed by the management unit;
an acquisition unit configured to acquire configuration information of the network device;
a determination unit configured to determine,
based on the configuration information of the network device acquired by the acquisition unit, whether the script managed by the management unit needs to be corrected; and
a correction unit configured to correct the script if it is determined by the determination unit that the script managed by the management unit needs to be corrected,
wherein the management unit manages the script corrected by the correction unit.

2. The management apparatus according to claim 1, wherein the determination unit further determines whether correction of the script is available without any user operation,
wherein the management apparatus further comprises a display control unit configured to perform display control of a correction screen used to correct the script by a user operation, if it is determined by the determination unit that correction of the script is not available without any user operation, and
wherein the management unit manages the script corrected via the correction screen.

3. The management apparatus according to claim 2, wherein correction of the script via the correction screen is performed by correcting the script displayed on the correction screen by a user input.

4. The management apparatus according to claim 2, wherein correction of the script via the correction screen is performed by correcting the script based on a record of an operation on a web page provided by the network device, the operation being performed by a user via the correction screen.

5. The management apparatus according to claim 2, wherein the display control unit displays an error occurrence location of the script on the correction screen.

6. The management apparatus according to claim 1, wherein, if the execution unit fails in the operation on the network device using the managed script and a cause of failure in the operation on the network device is not a communication error, the acquisition unit acquires the configuration information of the network device, and the determination unit determines whether the script managed by the management unit needs to be corrected.

7. The management apparatus according to claim 1, further comprising a detection unit configured to detect an operation for configuration change on the network device,
wherein, if the operation for configuration change on the network device is detected by the detection unit, the acquisition unit acquires the configuration information of the network device, and the determination unit determines whether the script managed by the management unit needs to be corrected.

8. The management apparatus according to claim 1, wherein the operation on the network device is an operation for setting information to the network device or an operation for acquiring information from the network device.

9. The management apparatus according to claim 1, wherein the management unit further manages task information in which the script is associated with a network device targeted for execution of the script, and
wherein the management apparatus further comprises a switching unit configured to switch the script associated with the network device in the task information to a script determined to coincide with the configuration information of the network device acquired by the acquisition unit from among scripts managed by the management unit.

10. The management apparatus according to claim 1, wherein the configuration information of the network device includes at least one of information about settings of the network device, information about an optional device connected to the network device, and information about an application installed on the network device.

11. The management apparatus according to claim 1, wherein the management unit further manages history of page configuration information of the web page provided by the network device,
wherein the determination unit further determines whether correction of the script is available without any user operation, based on a difference between current page configuration information and past page configuration information of the web page provided by the network device, and
wherein the correction unit corrects the script based on the difference in page configuration information of the web page.

12. The management apparatus according to claim 11, wherein the page configuration information of the web page includes page hierarchy information of the web page and HyperText Markup Language information of the web page.

13. A control method for a management apparatus including a management unit configured to manage, as a script, an instruction required for an operation on a network device and issued via a web page provided by the network device, and an execution unit configured to execute the operation on the network device via the web page provided by the network device by use of the script managed by the management unit, the control method comprising:
acquiring configuration information of the network device;
determining, based on the acquired configuration information of the network device, whether the script managed by the management unit needs to be corrected;
correcting the script if it is determined that the script managed by the management unit needs to be corrected; and
causing the management unit to manage the corrected script.

14. A non-transitory computer-readable storage medium storing a computer program that causes a computer to execute a control method for a management apparatus including a management unit configured to manage, as a script, an instruction required for an operation on a network device and issued via a web page provided by the network device, and an execution unit configured to execute the operation on the network device via the web page provided by the network device by use of the script managed by the management unit, the control method comprising:
acquiring configuration information of the network device;
determining, based on the acquired configuration information of the network device, whether the script managed by the management unit needs to be corrected;
correcting the script if it is determined that the script managed by the management unit needs to be corrected; and
causing the management unit to manage the corrected script.
